(19) United States
(12) Patent Application Publication
(10) Pub. No.: US 2012/0017743 A1
(43) Pub. Date: Jan. 26, 2012

(54) CUTTING MACHINES

(76) Inventors: Philippe PIERRET, Corbion (BE); Thierry Pierret, Sainte-Marie/Semois (BE)

(21) Appl. No.: 13/184,850

(22) Filed: Jul. 18, 2011

(30) Foreign Application Priority Data
Jul. 23, 2010 (EP) 10170719.8

(51) Int. Cl. B23D 35/00; B23D 33/00

(52) U.S. Cl. 83/699.51; 83/698.11

(57) ABSTRACT

Described herein is a mounting arrangement (400) for a fixed cutting blade (100) of a cutting machine (450) that allows rapid replacement of the cutting blade (100) without having to remove a support member (200) for the cutting blade (100) from the cutting machine (450). At each mounting point of the cutting blade (100), a shaped nut (300) is located within the support member (200) prior to the support member (200) being mounted on the cutting machine (450). Each shaped nut (300) has an eccentric flange that engages within a complementary recess formed in the support member (200), the nut being retained within the complementary recess by means of a circlip (410). A screw or bolt (420) engages with the nut (300) to mount the cutting blade (100) on the support member (200), and, as the screw or bolt (420) is tightened, the cutting blade (100) is precisely aligned with respect to x- and y-axes within the support member (200).

The present invention relates to improvements in or relating to cutting machines and is more particularly concerned with the mounting of a fixed cutting blade on such a cutting machine.

BE-A-1000675 discloses a fibre cutting machine in which fibres are aligned in a direction which is substantially perpendicular to the vertical plane of an edge of a fixed cutting blade to form a band. The band is conveyed step-by-step towards the fixed cutting blade and at least one mobile cutting blade and is supported in the vicinity of the fixed cutting blade so that its bottom face and lateral faces are each supported by a surface. Contacting surfaces grip the band as it is advanced towards the cutting blades by an amount equal to the length of the fibre sections to be cut. The band is brought to a temporary standstill and is clamped between support surfaces so that a portion of the band extends between the mobile and fixed cutting blades. The mobile cutting blade moves towards and past the fixed cutting blade to sever the band of fibres so that the fibres are cut to a predetermined size or length. Once the fibres have been cut, the band is released by the supporting surfaces and the contacting surfaces move away from the vicinity of the fixed cutting blade to grip the band at a predetermined distance away therefrom to advance the band towards the fixed cutting blade. The supporting surfaces, the contacting surfaces and the mobile cutting blade operate in synchronism to move the band and clamp it in position during the cutting phase.

The fixed and mobile cutting blades are detachably mounted on respective supports and it is necessary to replace both cutting blades at regular intervals. However, both blades need to be precisely aligned and stably mounted on their respective supports. In particular, it is important that these blades can be quickly and reliably replaced to reduce the down-time of the fibre cutting machine.

FR-A-2782465 discloses apparatus for cutting plastic material in which a fixed cutting blade is fixed to a support using a tightening connection. The cutting blade has a plurality of orifices in the form of through-holes provided along its length. The orifices in the cutting blade are aligned with a plurality of orifices formed in the support that are tapped along part or part of their length to accept screws or bolts to fix the cutting blade to its support. The support has a reference face and the cutting blade is angled with respect to that face. The orifices formed in the support have an axis that is angled with respect to the reference face. In the arrangement described, it is difficult to align the cutting blade precisely with respect to its support in all directions.

It is therefore an object of the present invention to provide an arrangement for mounting a fixed cutting blade on a cutting machine so that the blade can readily be removed and replaced, the cutting blade being positioned with high accuracy.

In accordance with one aspect of the present invention, there is provided a mounting arrangement for attaching a component to a support member, the mounting arrangement comprising a nut element located within a recess in the support member and a fastener for engaging the nut element;

characterised in that the nut element has an eccentric portion, and the recess has a portion shaped to be complementary to the eccentric portion of the nut element to prevent relative rotation between the nut element and the support member;

and in that the fastener passes through portions of the component and the support member at an angle relative to at least one engagement surface between the component and the support member.

In accordance with another aspect of the present invention, there is provided a cutting machine having a mounting arrangement for attaching a cutting blade to a support member, the mounting arrangement comprising a nut element located within a recess in the support member and a fastener for engaging the nut element;

characterised in that the nut element has an eccentric portion, and the recess has a portion shaped to be complementary to the eccentric portion of the nut element to prevent relative rotation between the nut element and the support member; and in that the fastener passes through portions of the cutting blade and the support member at an angle relative to at least one engagement surface between the component and the support member.

In a cutting machine, it is preferred that a retaining member is provided for retaining the shaped nut element within the recess in the support member.

This is because, when the fastener is released from the shaped nut element and the cutting blade is removed, there is a risk that the shaped nut element will be dislodged from the recess and the cutting machine will have to be dismantled, and subsequently rebuilt, in order to replace the shaped nut element in the correct position to accept the fastener when a new cutting blade is fitted. This is both time-consuming and costly due to excessive down-time of the cutting machine.

The retaining member may comprise a circlip located within an annular groove formed around part of the recess in the support member. The circlip is an inexpensive way of retaining the shaped nut element in the correct position within the recess so that there is little or no relative rotation between the shaped nut element and the complementary recess.

Ideally, the eccentric portion of the shaped nut element and the complementary portion of the recess are sized to allow for relative adjustment therebetween.

The eccentric portion may comprise a flange portion formed on the nut element, and preferably, the flange portion includes a flat portion which interacts with the complementary recess to reduce the relative rotation between the shaped nut element and the complementary recess.

For a better understanding of the present invention, reference will now be made, by way of example only, to the accompanying drawings in which :

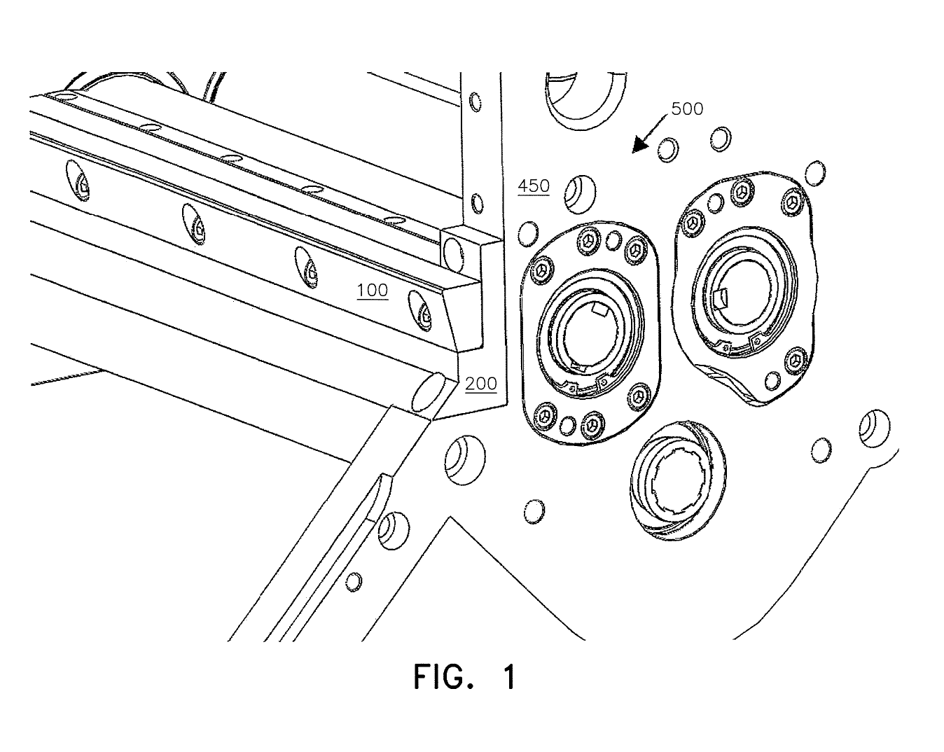

FIG. 1 illustrates how the mounting arrangement according to the invention is applied to a cutting machine.

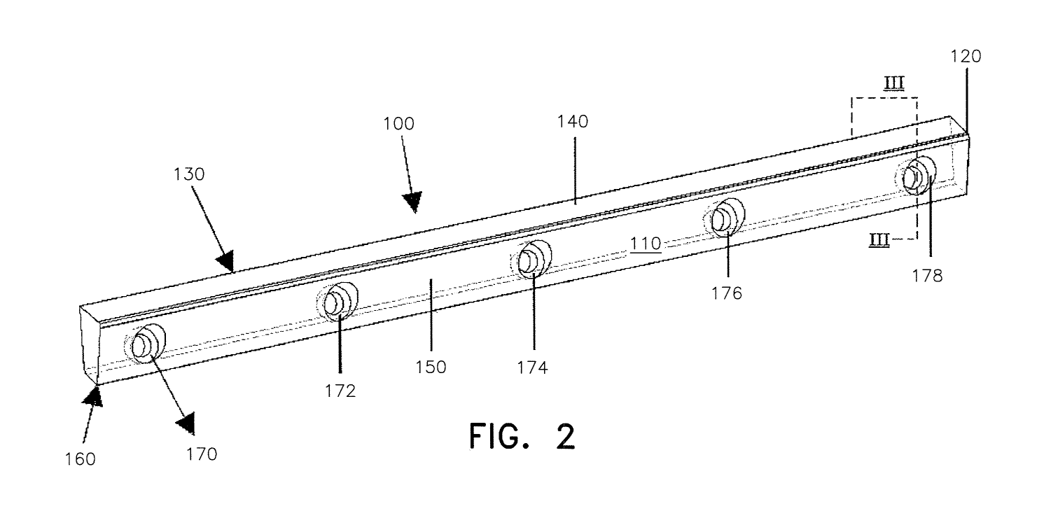

FIG. 2 illustrates a perspective view of a cutting blade in accordance with the present invention;

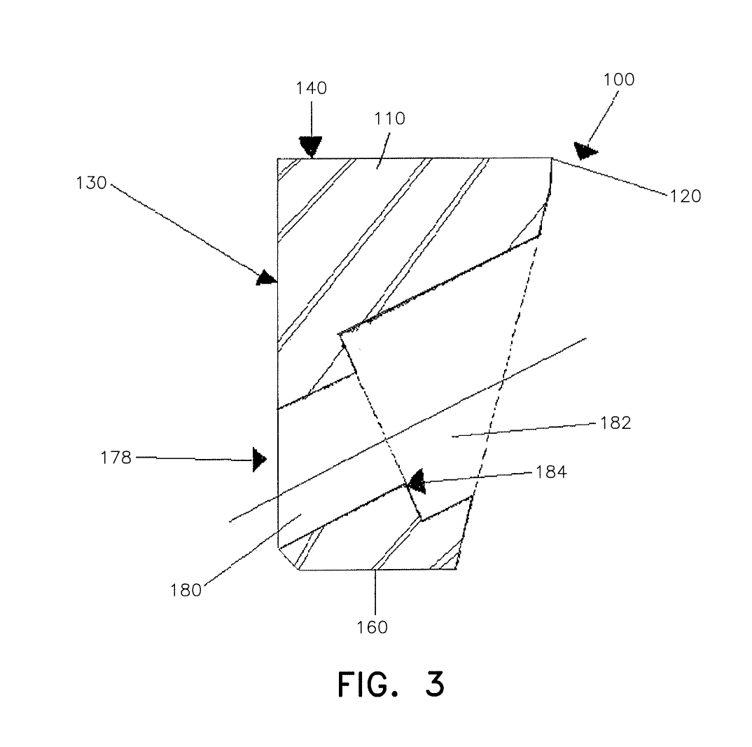

FIG. 3 illustrates a section III-HI through a hole formed in the cutting blade shown in FIG. 2;

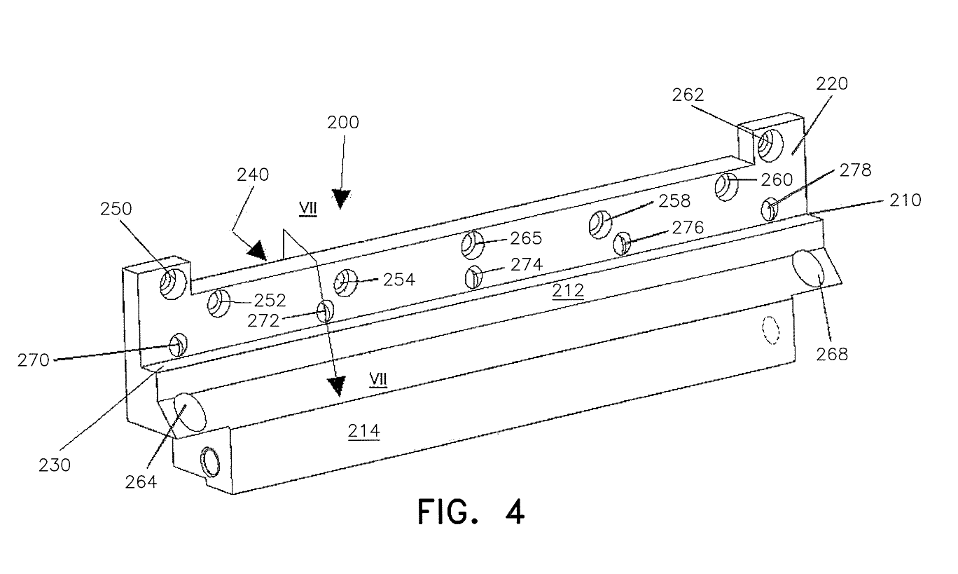

FIG. 4 illustrates a perspective view of a support for the cutting blade shown in FIGS. 1 to 3 in accordance with the present invention;

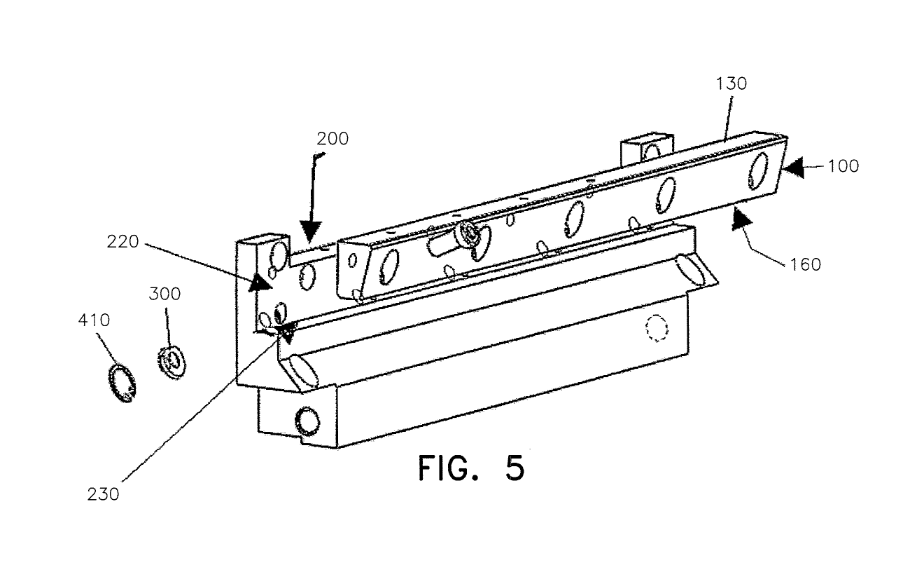

FIG. 5 illustrates a perspective view of the support shown in FIG. 4;

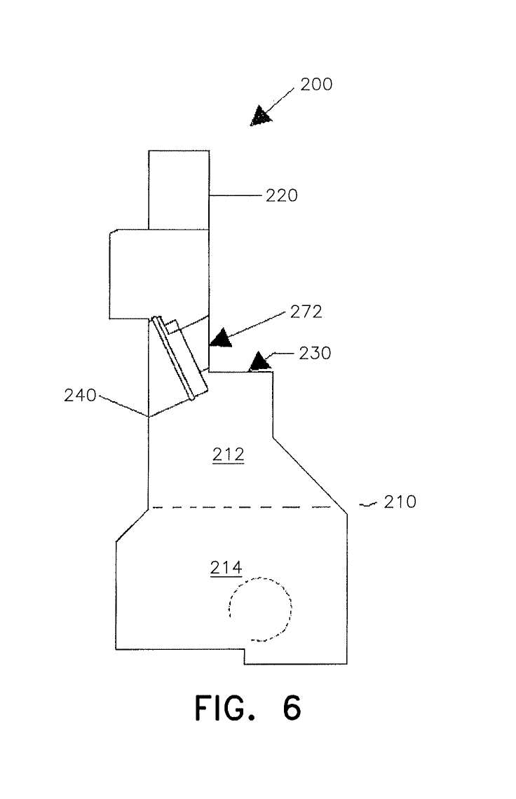

FIG. 6 illustrates an end elevation of the support shown in FIG. 4;

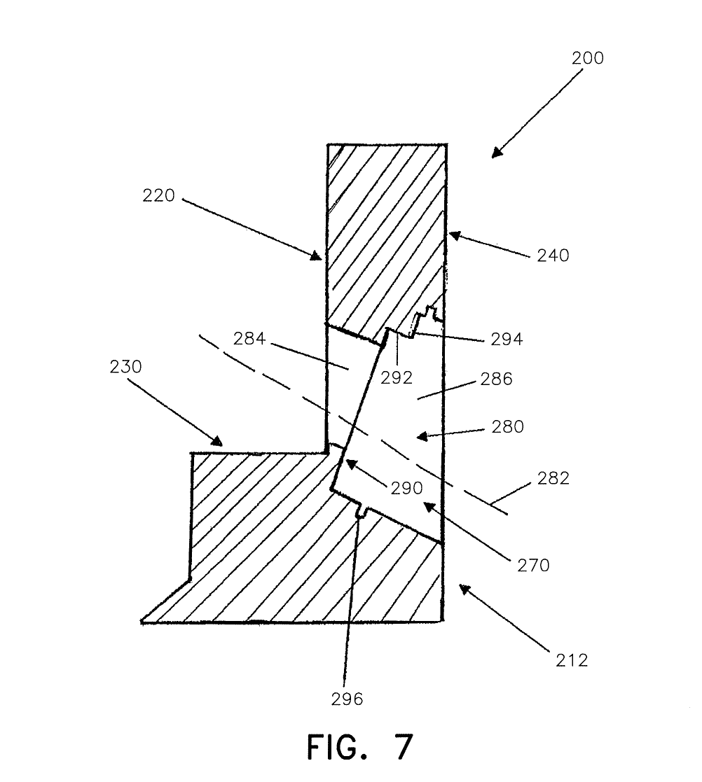

FIG. 7 illustrates a section through a hole formed in the support shown FIGS. 4 to 6 but only showing the top portion of the support;

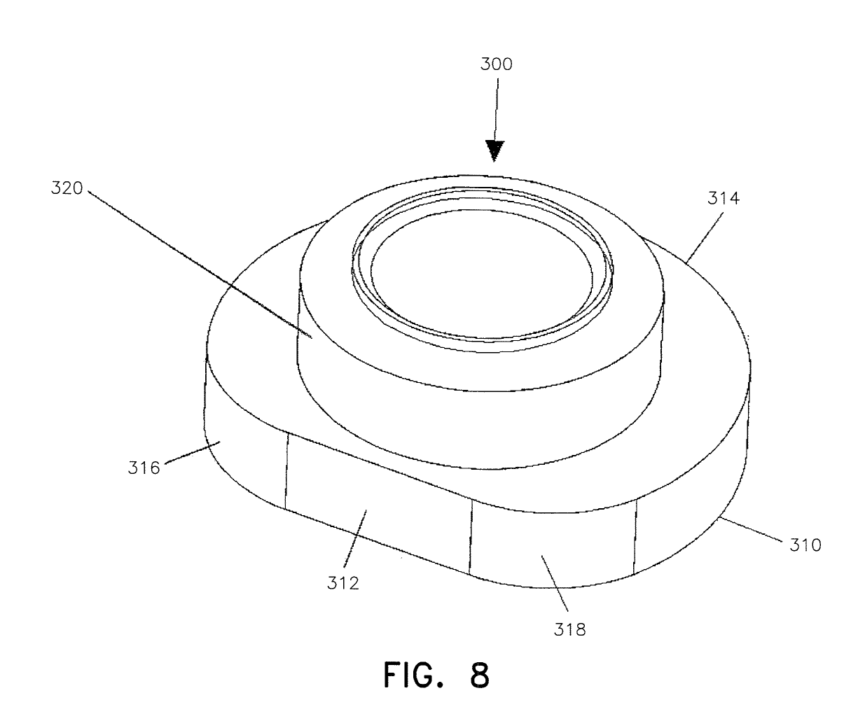

FIG. 8 illustrates a perspective view of a nut in accordance with the present invention;

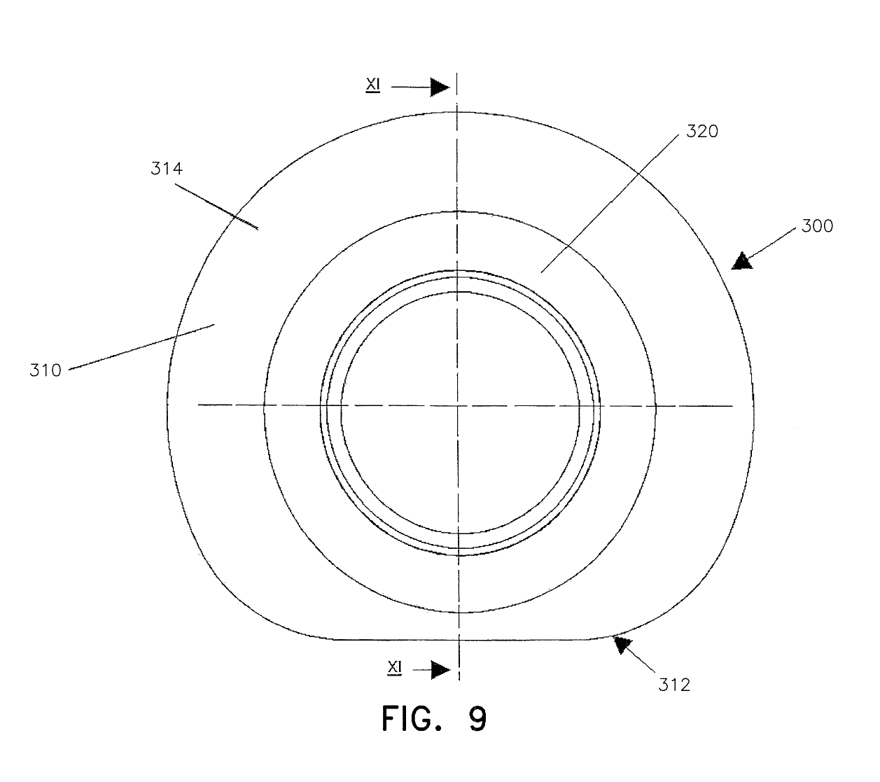

FIG. 9 illustrates a plan view of the nut shown in FIG. 8;

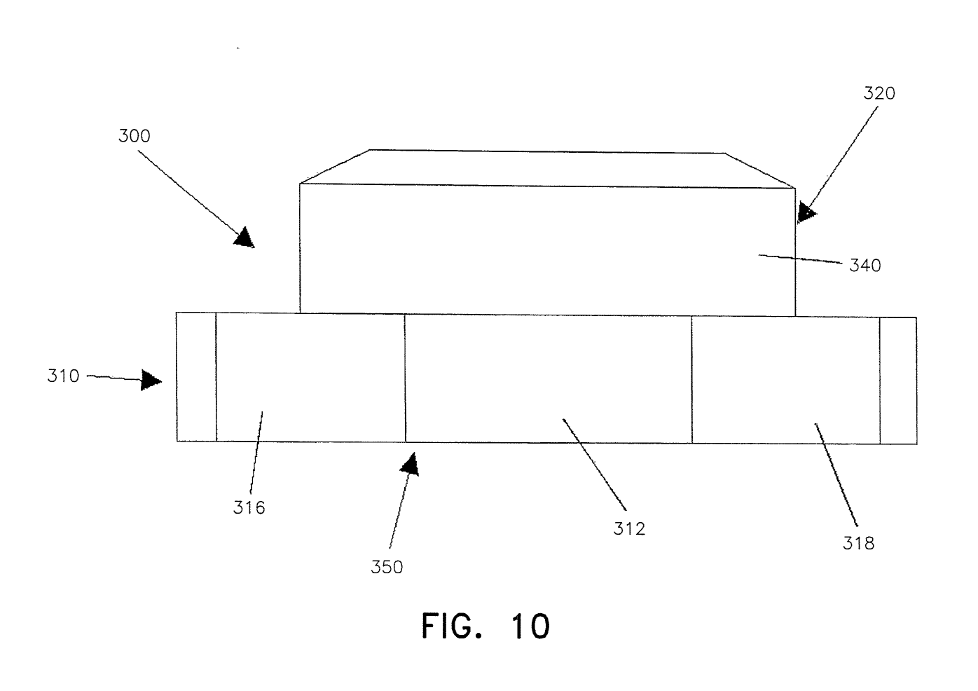

FIG. 10 illustrates a side elevation of the nut shown in FIG. 8;

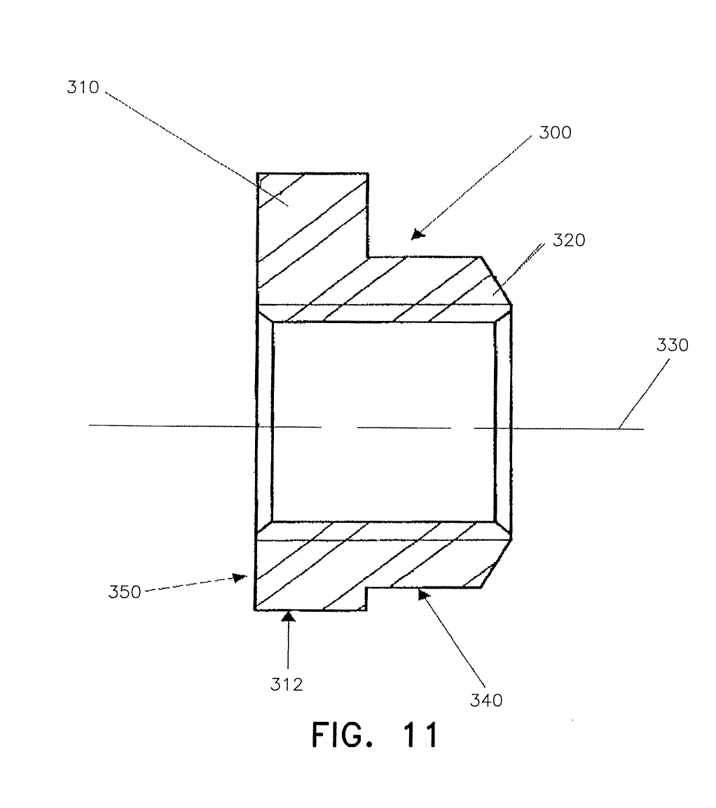

FIG. 11 illustrates a section XI-XI through the nut shown in FIG. 9;

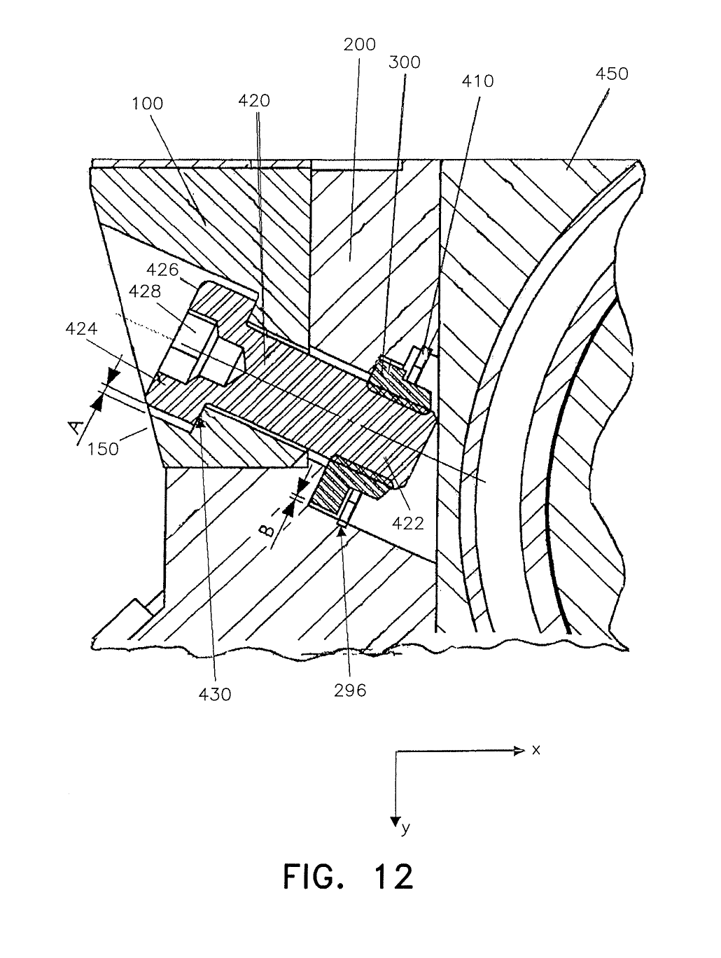

FIG. 12 illustrates a sectioned view illustrating a cutting blade mounted on its support and fixed in position on a fixing surface of a cutting machine; and

In the drawings a same reference is allotted to same or a corresponding element.

The mounting arrangement in accordance with the present invention is described in relation to the mounting and support of a fixed cutting blade for a cutting machine. However, it will be appreciated that the mounting arrangement of the present invention is not limited to use on cutting machines and can be used in other applications where a component needs to be mounted or connected to another component with accuracy.

FIG. 1 shows a part of a cutting machine 500 having a frame 450 to which a support member 200 is attached in a demountable manner. The latter serves to attach the fixed cutting blade 100 in such a manner that the cutting blade can be mounted and demounted from the support member.

Referring to FIGS. 2 and 3, the fixed cutting blade 100 is shown. The blade 100 has a body portion 110 and a cutting edge 120. The cutting edge extends over substantially the whole length of the body portion The body portion 110 comprises a first reference face 130, a top face 140 located adjacent the cutting edge 120 and the first reference face 130, a mounting face 150, and a second reference face 160. First and second reference faces 130 and 160 are used to position the cutting blade 100 against a support member (not shown) as will be described in more detail below. The first reference face forms a back side of the cutting blade and the second reference face forms a bottom side of the cutting blade when the latter is mounted on the support member.

Five mounting holes 170, 172, 174, 176, 178 are shown spaced along the length of the body portion 110 and extending through the body portion from mounting face 150 towards the reference face 130. The mounting holes 170, 172, 174, 176, 178 are angled with respect to the first reference face 130, as is shown more clearly in FIG. 3.

Although only five mounting holes 170, 172, 174, 176, 178, are illustrated, it will be appreciated that the number of mounting holes required are chosen in accordance with the application of the particular mounting arrangement.

In FIG. 3, it can be seen more clearly that each mounting hole 170, 172, 174, 176, 178 comprises a first portion 180 having a diameter sized to receive the threaded portion of a fixing screw or bolt (not shown) and a second portion 182 having a diameter greater than the first portion 180 and sized to receive and to retain the head of the fixing screw or bolt (not shown). The change in diameter between first portion 180 and second portion 182 provides a surface 184 against which the head of the fixing screw or bolt abuts as will be described in more detail below.

FIGS. 4 to 7 illustrate a support member 200 for the cutting blade 100. The support member 200 has a body portion 210 having an upper part 212 and a lower part 214. The upper part 212 is shaped to provide locating faces 220 and 230 for the cutting blade 100. The first reference face 130 and the second reference face 160 of the cutting blade 100 abutting the locating face 220 and the locating face 230 respectively. The body portion 210 also has a back face 240 that abuts a fixing surface 450 of a cutting machine 500.

The support member 200 is provided with a plurality of fixing holes 250, 262, 264, 268 for mounting the support member to the fixing surface of the cutting machine (both not shown). The support member 200 also has a five mounting holes 270, 272, 274, 276, 278 for attaching the cutting blade 100 thereto and thus for fixing the cutting blade via the support member to the cutting machine.

FIG. 7 shows a cross section through the upper part 212 of the body portion 210 of the support member 200 along the line VII-VII. A mounting hole 272 (one of the mounting holes 270, 272, 274, 276, 278 provided for attaching the cutting blade 100 to the support 200) is clearly shown. The mounting hole 272 comprises a through-hole 280 that extends from the locating face 220 to the back face 240 of the support member 200.

The through-hole 280 has an axis 282 and comprises a first part 284 and a second part 286 as shown. The first part 284 is symmetrical about the axis 282 and receives the shaft of a screw or bolt (not shown) that passes through one of the mounting holes 170, 172, 174, 176, 178 formed in the body portion 110 of the cutting blade 100 (not shown). The second part 286 is shaped to receive a shaped nut (described below in more detail with reference to FIGS. 8 to 10) that abuts against surface 290 located adjacent the end of the first part 284 when the cutting blade 100 is fully mounted on the support member 200.

It is to be noted that surface 290 is not symmetrical about the axis 282 as, on one side of the through-hole 280, a shoulder 292 is provided for locking the shaped nut (not shown) in position relative to a transverse direction extending across the through-hole 280, that is, perpendicular to the axis 282. The operation of this feature will be described in more detail below with reference to FIGS. 8 to 12.

A further shoulder 294 is provided adjacent shoulder 292 as shown in FIG. 7. An annular slot or groove 296 is formed in the body portion 210 of the support member 200 inside the through-hole 280 for retaining a circlip 410 (FIG. 5) against the further shoulder 294 and hence the shaped nut in position so that it cannot move in a direction along the axis 282 and away from surface 290.

Turning now to FIGS. 8 to 11, a shaped nut 300 in accordance with the present invention is shown. The nut 300 comprises a flange portion 310 and a boss portion 320 arranged along an axis 330. The boss portion 320 is generally cylindrical and is symmetrical around the axis 330. The flange portion 310 is asymmetrical with respect to the axis 330.

The boss portion 320 has a smaller diameter than the flange portion 310 and protrudes from the flange portion 310 in a direction that extends along the axis 330 to provide a cylindrical surface 340 over which the circlip (not shown) is placed when assembled.

A surface 350 of the flange portion 310 abuts surface 290 of the through-hole 280 formed in the body portion 210 of the support member 200 when assembled as is described in more detail below with reference to FIG. 12.

As shown in figures .8 to 11, the flange portion 310 is not symmetrical about the axis 330. It comprises a flat portion 312 and a substantially circular portion 314 arranged such that the flat portion 312 is closer to the axis 330 than the substantially circular portion 314. Two joining portions 316, 318 join the substantially circular portion 314 to the flat portion 312 as shown. As shown, the inside of the boss portion 320 and the flange portion 310 is threaded so as to receive a suitable screw or bolt (not shown) when assembled.

Referring now to FIG. 12, an assembly 400 is shown that comprises the cutting blade 100, the support member 200 and the shaped nut 300 mounted on a cutting machine 450 only part of which is shown. Reference numerals for components that have been previously with respect to FIGS. 1 to 11 described remain the same.

During initial assembly of the cutting blade 100, the support member 200 and the shaped nut 300, the support member 200 is not mounted on the cutting machine 450. This is because, once the support member 200 is fixed to the cutting machine 450, it is not possible to insert the shaped nut 300 within the second part 286 of the through-hole 280 (FIG. 7).

For ease of explanation, only one hole is described, but it will readily be appreciated that the same process is carried out for each of the mounting holes 170, 172, 174, 176, 178 of the body portion 110 of the cutting blade 100 (FIGS. 1 to 3) and the mounting holes 270, 272, 274, 276, 278 of the body portion 210 of the support member 200 (FIGS. 4 to 7).

For each mounting position as defined by mounting holes 170, 172, 174, 176, 178 of body portion 110 and 270, 272, 274, 276, 278 of the body portion 210, one shaped nut 300 is located in the second part 286 of the through-hole 280 (FIG. 7) with the flat portion 312 of the flange portion 310 of the nut 300 adjacent the further shoulder 292 and the surface 350 of the flange portion 310 adjacent shoulder 290. The nut 300 is retained in place by means of a circlip 410 which surrounds the cylindrical surface 340 of the boss portion 320 and engages with the annular slot or groove 296 formed in the second part 286 of the through-hole 280 (FIG. 7). The circlip 410 is a standard circlip having a dimension which fits with the one of the boss portion 320. In the particular embodiment described here, the circlip comprises a circlip designated as DIN 472-I22. The circlip retains the nut 300 into the through-hole 280 when the cutting blade is removed from the support.

Once the nut 300 is retained in place within the through-hole 280 of the body portion 210 of the support member 200 for each of the mounting holes 270, 272, 274, 276, 278, the support member 200 is attached to the cutting machine 450 by screws or bolts (not shown) inserted into the fixing holes 250, 262, 264, 268.

Once the support member 200 is mounted on the machine 450, the cutting blade 100 is positioned against the support member 200 with the first and second reference faces 130 and 160 of the body portion 110 of the cutting member 100 abutting respective locating surfaces 220 and 230 of the body portion 210 of the support member 200 with the mounting holes 170, 172, 174, 176, 178 of body portion 110 of the cutting blade 100 and mounting holes 270, 272, 274, 276, 278 of the body portion 210 of the support member 200 substantially aligned (FIGS. 1 to 6).

For each mounting hole pair formed by respective ones of the mounting holes 170, 172, 174, 176, 178 of body portion 110 of the cutting blade 100 and mounting holes 270, 272, 274, 276, 278 of the body portion 210 of the support member 200, a screw or bolt 420 is introduced into the hole pair through the mounting face 150 of the body portion 110 of the cutting blade 100 and into the nut 300.

The screw or bolt 420 has a threaded portion 422 and a head portion 424 having a top surface 426, in which means 428 are provided for turning the screw or bolt 420, and an under surface 430 which abuts surface 184 in the first portion 182 of a hole 170 in the body portion 110 of the cutting blade 100 (FIG. 3).

As the screw or bolt 420 is turned relative to the body portion 110 of the cutting blade 100, the threaded portion 422 engages the thread formed on the inside of the flange portion 310 and the boss portion 320 of the nut 300 and tightens so that the first and second reference faces 130 and 160 of the body portion 110 of the cutting blade 100 abut against the locating surfaces 220 and 230 of the body portion 210 of the support member 200. Tightening continues until under surface 430 of the screw or bolt 420 abuts surface 184 of the first portion 182 (FIG. 3) of the mounting hole formed in the body portion 110 of the cutting blade 100 and surface 350 of the flange portion 310 abuts surface 290 of the through-hole 280 formed in the body portion 210 of the support member 200.

The screw or bolt 420 comprises a standard screw or bolt that can be sourced in any suitable size to match the internal thread of the nut 300. In the particular embodiment described here, the screw or bolt comprises one designated as DIN 6912 M20×25. Means 428 formed in the head portion 424 of the screw or bolt 420 may be adapted to be used with an Allen key or other similar hexagon wrench. Alternatively, the means 428 may be adapted to be used with a slot-head or Philips head screwdriver or the like.

It will readily be understood that due to the engagement of the flat portion 312 of the flange portion 310 with shoulder 292 in the second part 286 of the through-hole 280, the shaped nut 300 cannot rotate and therefore acts to lock the cutting blade 100 to the support member 200.

Once the cutting blade 100 is fully assembled on the support member 200 and the thus obtained mounting arrangement is mounted on the frame 450 of the cutting machine 500, there is perfect alignment along the x- and y-axes due to screws or bolts 420 being at an angle with respect to the cutting blade 100 and the support member 200. Indeed the force applied by the screws or bolts 420 is decomposed due to the angled orientation of the fixing hole in an x and y component pushing on the support member as well in the x as in the y direction.

It will be appreciated that the profile of the support member 200 is not linear due to the trajectory of a mobile cutting blade (not shown) against the fixed cutting blade 100. However, the assembly of the fixed cutting blade 100 and the support member 200 in accordance with the present invention gives the assurance of a perfect alignment that allows the cutting blade 100 to follow perfectly the profile of the support member 200.

The use of the shaped nut 300 in a non-circular hole within the support member 200 provides the following advantages:-
a) There is no need for special tools for mounting of the cutting blade 100 as the special shape of the nut 300 prevents turning within the support member 200. Moreover, a simple Allen key, screwdriver or the like can be used to engage means 428 in the head portion 424 of the screws or bolts 420 as the nut is always retained in position within the support member 200 by the circlip 410 and the flat portion 312 of the flange portion 310 of the nut 300 abutting the shoulder 292.
b) The mounting holes 170, 172, 174, 176, 178 in the body portion 110 of the cutting blade 100 do not need to be very precise as there is a tolerance between the sizing of portion 182 of the hole 170 (FIG. 3) and the head portion 424 of the screw or bolt 420 as indicated by ‘A’ in FIG. 12. There is also a tolerance between the sizing of the second portion 286 of the through hole-280 (FIG. 7) and the nut 300 as indicated by ‘B’ in FIG. 12. In such a manner the movement of the cutting blade towards the support member 200, while mounting, is not hindered
c) As the screws or bolts 420 are not directly fixed in the support member 200 but into the nut 300 retained within the support member by the circlip 410, the support member 200 is protected from damage as the frequency of the demounting and remounting of the fixed cutting blade 100 can be several times a day.

In accordance with the present invention, the cutting blade 100 can easily be replaced without having to remove the support member 200 from the cutting machine 450. This means that the support member 200 can be precisely retained in position on the cutting machine 450 and the cutting blade 100 can be removed and replaced as necessary.

1. A mounting arrangement for attaching a component to a support member, the mounting arrangement comprising a nut element located within a recess in the support member and a fastener for engaging the nut element;
characterised in that the nut element has an eccentric portion, and the recess has a portion shaped to be complementary to the eccentric portion of the nut element to prevent relative rotation between the nut element and the support member;
and in that the fastener passes through portions of the component and the support member at an angle relative to at least one engagement surface between the component and the support member.

2. A mounting arrangement according to claim 1, further comprising a retaining member for retaining the shaped nut element within the recess in the support member.

3. A mounting arrangement according to claim 2, wherein the retaining member comprises a circlip located within an annular groove formed around part of the recess in the support member.

4. A mounting arrangement according to claim 1, wherein the eccentric portion of the shaped nut element and the complementary portion of the recess are sized to allow for relative adjustment therebetween.

5. A mounting arrangement according to claim 1, wherein the eccentric portion comprises a flange portion formed on the nut element.

6. A mounting arrangement according to claim 5, wherein the flange portion includes a flat portion.

7. A mounting arrangement according to claim 1, wherein the component comprises a fixed cutting blade and the support member is mounted on a cutting machine.

8. A cutting machine having a mounting arrangement for attaching a cutting blade to a support member, the mounting arrangement comprising a nut element located within a recess in the support member and a fastener for engaging the nut element;
characterised in that the nut element has an eccentric portion, and the recess has a portion shaped to be complementary to the eccentric portion of the nut element to prevent relative rotation between the nut element and the support member;
and in that the fastener passes through portions of the cutting blade and the support member at an angle relative to at least one engagement surface between the component and the support member.

9. A cutting machine according to claim 8, further comprising a retaining member for retaining the shaped nut element within the recess in the support member.

10. A cutting machine according to claim 9, wherein the retaining member comprises a circlip located within an annular groove formed around part of the recess in the support member.

11. A cutting machine according to claim 8, wherein the eccentric portion of the shaped nut element and the complementary portion of the recess are sized to allow for relative adjustment therebetween.

12. A cutting machine according to claim 8, wherein the eccentric portion comprises a flange portion formed on the nut element.

13. A mounting arrangement according to claim 12, wherein the flange portion includes a flat portion.

14. A combination of a cutting member, a support member and a mounting arrangement for attaching the cutting member to the support member, the mounting arrangement further comprising a nut element located within a recess in the support member and a fastener for engaging the nut element;
characterised in that the nut element has an eccentric portion, and the recess has a portion shaped to be complementary to the eccentric portion of the nut element to prevent relative rotation between the nut element and the support member;
and in that the cutting member comprises holes through which the fastener passes when the cutting element is fixed to the support member, which fastener passes through the hole and the support member at an angle relative to at least one engagement surface between the cutting member and the support member.
